(19) United States
(12) Patent Application Publication
(10) Pub. No.: US 2025/0323235 A1
(43) Pub. Date: Oct. 16, 2025

(54) ELECTRODE STRUCTURE AND LITHIUM SECONDARY BATTERY INCLUDING THE SAME

(71) Applicant: Samsung SDI Co., Ltd., Yongin-si (KR)

(72) Inventors: Donghyun Shin, Yongin-si (KR); Hyejin Kwon, Yongin-si (KR); Jaehong Kim, Yongin-si (KR); Sungjin Seo, Yongin-si (KR); Dannbee Kim, Yongin-si (KR)

(21) Appl. No.: 19/012,740

(22) Filed: Jan. 7, 2025

(30) Foreign Application Priority Data
Apr. 16, 2024 (KR) 10-2024-0050918

(51) Int. Cl. H01M 4/02; H01M 4/04; H01M 4/66; H01M 10/052

(52) U.S. Cl. CPC H01M 4/02; H01M 4/0404; H01M 4/668; H01M 10/052; H01M 2004/021

(57) ABSTRACT

An electrode structure (e.g., a jelly-roll type or kind electrode structure) and a secondary battery including the same are provided. The electrode structure includes a cathode including a cathode active material layer, an anode including an anode active material layer, and a separator between the cathode and the anode. The electrode structure includes a coated portion in which the cathode or anode active material layer is arranged, and an uncoated portion that excludes (e.g., is free of) the cathode active material layer and the anode active material layer. Two ends of the electrode structure include a portion inside that is defined as 0 L and a portion outside that is defined as 100 L, each based on a longitudinal direction, and the uncoated portion is between 0 L and 50 L in the electrode structure.

### CROSS-REFERENCES TO RELATED APPLICATION

This application claims priority and the benefit of Korean Patent Application No. 10-2024-0050918, filed on Apr. 16, 2024, in the Korean Intellectual Property Office, the entire content of which is incorporated herein by reference.

### BACKGROUND

### 1. Field

According to one or more embodiments, the present disclosure relates to an electrode structure, and a lithium secondary battery including the electrode structure.

### 2 Description of the Related Art

In accordance with miniaturization and higher performance of one or more suitable devices (e.g., battery-powered electronics, such as mobile phones, laptop computers, and/or the like), it has become important for lithium batteries to have relatively higher energy density as well as miniaturization and weight reduction. That is, as devices like mobile phones and laptops become smaller and more powerful, it is increasingly important for lithium batteries to offer higher energy density while also being miniaturized and lightweight. In this regard, lithium batteries having relatively high capacity have become increasingly desired or important.

To achieve a lithium battery suitable for the preceding uses, electrodes with relatively high loading (e.g., of an electrode active material) are being investigated and developed.

In applying an electrode with relatively high loading to a jelly-roll type or kind electrode structure, during the process of winding the electrode to form a jelly-roll shape, the electrode may be prone to cracking in its core portion due to high curvature.

In this regard, a method of preventing or reducing crack formation in the electrode, while improving the energy density of the electrode structure, is desired or required.

### SUMMARY

One or more aspects are directed toward an electrode structure including an uncoated portion, and a lithium secondary battery including the electrode structure.

Additional aspects will be set forth in part in the description which follows and, in part, will be apparent from the description, or may be learned by practice of the presented embodiments of the present disclosure.

According to one or more embodiments,
an electrode structure (e.g., a jelly-roll type or kind electrode structure) includes a cathode including a cathode active material layer, an anode including an anode active material layer, and a separator positioned (e.g., arranged) between the cathode and the anode, wherein the electrode structure includes at least one coated portion in which the cathode active material layer or the anode active material layer is positioned (e.g., arranged), and at least one uncoated portion in which the cathode active material layer and the anode active material layer are not positioned (e.g., arranged), and two ends of the electrode structure include a portion positioned (e.g., arranged) inside is defined as 0 L and a portion positioned (e.g., arranged) outside is defined as 100 L, based on a longitudinal direction (e.g., “L”). The electrode structure includes the uncoated portion between 0 L and 50 L, but excludes (e.g., is free of) the uncoated portion between 50 L and 100 L.

According to one or more embodiments,
a lithium battery includes the electrode structure (e.g., jelly-roll type or kind electrode structure).

### BRIEF DESCRIPTION OF THE DRAWINGS

The preceding and other aspects, features, and advantages of certain embodiments of the present disclosure will be more apparent from the following description taken in conjunction with the accompanying drawings, in which:

FIGS. 1 and 3 are each a mimic diagram showing components included in an electrode structure prior to winding of the electrode structure, according to one or more embodiments;

FIGS. 2 and 4 are each a mimic diagram showing a jelly-roll type or kind electrode structure after winding of the jelly-roll type or kind electrode, according to one or more embodiments;

FIGS. 5-8 are each a schematic cross-sectional diagram of a lithium secondary battery according to one or more embodiments; and

FIG. 9 is a mimic diagram illustrating components included in an electrode structure prior to winding of the electrode structure, according to a Comparative Example.

### DETAILED DESCRIPTION

Hereinafter, embodiments of the present disclosure are described clearly and in more detail to such an extent that those skilled in the art easily implement the present disclosure. In order to sufficiently understand the configuration and effects of the present disclosure, embodiments of the present disclosure will be described with reference will now be made in more detail to one or more embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, one or more embodiments are merely described in more detail, by referring to the drawings, to explain aspects of the present description.

As used herein, the term “and/or” includes any and all combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

An electrode structure (e.g., jelly-roll type or kind electrode structure) according to one or more embodiments may include: a cathode including a cathode active material layer; an anode including an anode active material layer; and a separator positioned (e.g., arranged) between the cathode and the anode. The electrode structure includes a coated portion in which the cathode active material layer or the anode active material layer is positioned (e.g., arranged), and an uncoated portion in which the cathode active material layer and the anode active material layer are not positioned (e.g., arranged). Two ends of the electrode structure include a portion positioned (e.g., arranged) inside that is defined as 0 L and a portion positioned (e.g., arranged) outside that is defined as 100 L, each based on a longitudinal direction (e.g., “L”), the electrode structure, which includes the uncoated portion between 0 L and 50 L, and excludes (e.g., is free of) the uncoated portion between 50 L and 100 L. For example, the uncoated portion may be located only in a specific region in the electrode structure so that crack formation in the electrode structure can be prevented or reduced while energy density is improved.

The following examples are provided only to provide a better understanding of the present disclosure, and it will be apparent to those skilled in the art that the scope of the present disclosure is not restricted by these examples, but rather, the present disclosure is defined by the scope of claims, and may be implemented in one or more suitable forms and modified as required.

The terminology utilized herein is utilized for the purpose of describing particular embodiments only, and is not intended to limit the present disclosure. Unless otherwise defined, all terms, including chemical, technical and scientific terms, used herein have the same meaning as commonly understood by one of ordinary skill in the art to which the present disclosure belongs. In case of discrepancies, the present specification including definitions is considered in priority. It will be further understood that terms, such as those defined in commonly utilized dictionaries, should be interpreted as having a meaning that is consistent with their meaning in the context of the related art and the present disclosure, and will not be interpreted in an idealized or overly formal sense.

Although methods and materials similar or equivalent to those described herein can be used in the practice or testing of the present disclosure, suitable methods and materials are described herein. An expression used in the singular (e.g., “a,” “an,” and/or “the”) encompasses the expression of the plural, including “at least one,” unless it has a clearly different meaning in the context.

It will be further understood that the terms “comprises,” “comprise,” “comprising,” “includes,” “include,” “including,” “having,” “has,” and/or “have” as used in the present specification, specify the presence of stated features, integers, steps, operations, elements, components, ingredients, materials, steps (e.g., acts or tasks), and/or one or more (e.g., any suitable) combinations thereof, but do not preclude the presence or addition of one or more other features, integers, steps, operations, elements, components, ingredients, materials, steps (e.g., acts or tasks), and/or one or more (e.g., any suitable) combinations thereof.

The term “a combination thereof” as used herein refers to a mixture or combination of one or more of the aforementioned elements.

The term “may” will be understood to refer to “one or more embodiments of the present disclosure,” some of which include the described element and some of which exclude that element and/or include an alternate element. The term “and/or” as used herein is meant to include any and all combinations of one or more of the items listed in relation thereto. The term “or” as used herein refers to “and/or”. The expression “at least one” or “one or more” used in front of components in the present specification is meant to supplement a list of all component elements, and does not imply to supplement individual components of the description. Unless otherwise specified, the phrase “A or B” may indicate “A but not B”, “B but not A”, or “A and B”.

The phrase “consisting essentially of” indicates that any additional components will not materially affect the chemical, physical, optical or electrical properties of the electrode structure (jelly-roll type or kind electrode structure).

In the drawings, thicknesses may be magnified or exaggerated to clearly illustrate one or more suitable layers and regions. Like reference numbers may refer to like elements throughout, and duplicative descriptions thereof may not be provided the drawings and the following description. Throughout the specification, if (e.g., when) a component, such as a layer, a film, a region, or a plate, is described as being “above” or “on” another component, the component may be directly above the other component, or there may be yet another component therebetween. In contrast, if (e.g., when) an element is referred to as being “directly on” another element, there are no intervening elements present.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

Although the terms “first,” “second,” and/or the like may be used herein to describe one or more suitable elements, components, regions, layers or sections these elements should not be limited by these terms. These terms are only used to distinguish one element, component, region, layer or section from another element. Thus, a first element, component, region, layer, or section described herein may be termed a second element, component, region, layer or section without departing from the teachings set forth herein.

The term “layer” as used herein includes not only a shape formed on the whole surface if (e.g., when) viewed from a plan view, but also a shape formed on a partial surface.

The phrase “plan view,” indicates viewing a target portion from the top, and the phrase “on a cross-section” indicates viewing a cross-section formed by vertically cutting a target portion from the side.

The term “metal” as used herein refers to both (e.g., simultaneously) metals and metalloids such as silicon and germanium, in an elemental or ionic state.

The term “alloy” as used herein refers to a mixture of two or more metals.

As used herein, the term “cathode active material” refers to a cathode material capable of undergoing lithiation and delithiation.

As used herein, the term “anode active material” refers to an anode material capable of undergoing lithiation and delithiation.

As used herein, the terms “lithiation” and “to lithiate” refer to a process of adding lithium to a cathode active material or an anode active material.

As used herein, the terms “delithiation” and “to delithiate” refer to a process of removing lithium from a cathode active material or an anode active material.

As used herein, the terms “charging” and “to charge” refer to a process of providing electrochemical energy to a battery.

As used herein, the terms “discharging” and “to discharge” refer to a process of removing electrochemical energy from a battery.

As used herein, the terms “positive electrode” and “cathode” refer to an electrode at which electrochemical reduction and lithiation take place during a discharging process.

As used herein, the terms “negative electrode” and “anode” refer to an electrode at which electrochemical oxidation and delithiation take place during a discharging process.

With reference to the accompanied drawings, an electrode structure, and a lithium battery including the same will be described in greater detail.

### Electrode Structure 1

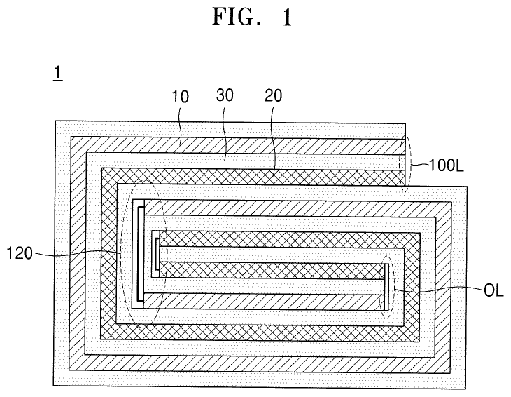

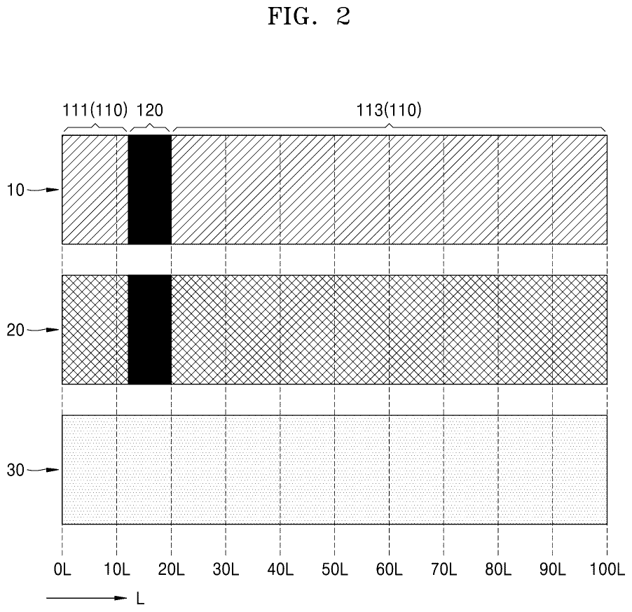

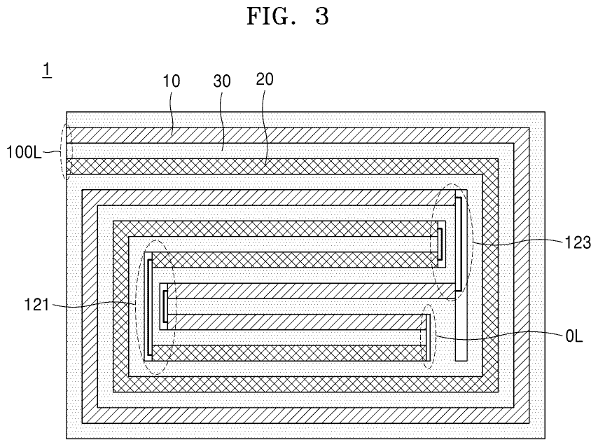

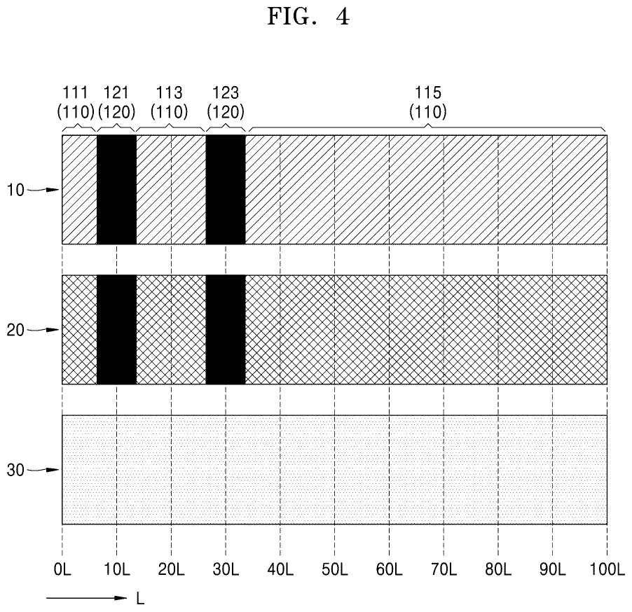

FIGS. 1 and 3 are each a mimic diagram showing an electrode structure (e.g., jelly-roll type or kind electrode structure) after winding, according to one or more embodiments. FIGS. 2 and 4 are each a mimic diagram showing components included in the electrode structure prior to winding of the electrode structure, according to one or more embodiments.

Referring to FIGS. 1 to 4, an electrode structure (e.g., jelly-roll type or kind electrode structure) 1 may include: a cathode 10 including a cathode active material layer; an anode 20 including an anode active material layer; and a separator 30 arranged between the cathode 10 and the anode 20. Further, the electrode structure 1 may include: a coated portion 110 in which the cathode active material layer or the anode active material layer is positioned (e.g., arranged); and an uncoated portion 120 in which the cathode active material layer and the anode active material layer are excluded (e.g., not arranged or positioned). The electrode structure may include two ends, e.g., an inside end and an outside end. For example, the inside end may be a portion positioned (e.g., arranged) inside the electrode structure that is defined as 0 L (e.g., a 0 L location) and the outside end may be a portion positioned (e.g., arranged) outside the electrode structure that is defined as 100 L (e.g., a 100 L location), each of 0 L and 100 L may be based on a longitudinal direction (e.g. “L”). In some embodiments, the electrode structure 1 may include the uncoated portion 120 between 0 L and 50 L (e.g., a 50 L location), and may exclude (e.g., be free of) the uncoated portion 120 between 50 L and 100 L. For example, the 0 L location (e.g., inside end) may be (e.g., a region or part) where the winding of the electrode structure 1 starts, and the 100 L location (e.g., outside end) may be (e.g., a region or part) where the winding of the electrode structure 1 concludes or ends. For example, the coated portion 110 may refer to a region in which the cathode active material layer or the anode active material layer is arranged or positioned, and the uncoated portion 120 may refer to a region in which the cathode active material layer and the anode active material layer are excluded (e.g., not arranged or positioned). For example, the uncoated portion 120 may refer to a region in which an electrode active material layer (e.g., a cathode active material layer or anode active material layer) is not provided (e.g., absent) on an electrode current collector (e.g., a cathode current collector or anode current collector). For example, the uncoated portion 120 may refer to a metal pattern connecting between regions in which the cathode active material layer or the anode active material layer is arranged or positioned.

For example, the uncoated portion 120 in the electrode structure (e.g., jelly-roll type or kind electrode structure) 1 may be arranged or positioned between 0 L and 50 L of the electrode structure, (i.e., at a region or part where the winding of the electrode structure starts), and the uncoated portion 120 may be excluded (e.g., not be arranged or positioned) between 50 L and 100 L of the electrode structure, (i.e., at a part where the winding of the electrode structure concludes or ends). In such a case, the inside end (e.g., internal region), (i.e., the region or part where the winding of the electrode structure 1 starts), of the electrode structure 1 may have a reduced risk of crack formation because the uncoated portion 120 is positioned (e.g., arranged) in the aforementioned portion. The skilled artisan will appreciate that a jelly-roll type or kind electrode structure of the related art that includes an inside end with a coated portion may be highly likely to crack due to high curvature.

In some embodiments, because the uncoated portion 120 is excluded (e.g., not arranged or positioned) between 50 L and 100 L, i.e., the region or part where the winding of the electrode structure concludes or ends and therefore is relatively less likely to crack, the energy density of the electrode structure 1 may be enhanced or improved.

According to one or more embodiments, the uncoated portion 120 may be positioned (e.g., arranged) between 0 L and 40 L (e.g., a 40 L location) within the electrode structure 1. For example, the uncoated portion 120 may be positioned (e.g., arranged) between 0 L and 30 L (e.g., a 30 L location), between 5 L (e.g., a 5 L location) and 30 L, or between 10 L (e.g., a 10 L location) and 30 L, in the electrode structure 1.

According to one or more embodiments, the electrode structure 1 may exclude (e.g., be free of) the uncoated portion 120 between 40 L and 100 L. For example, the electrode structure 1 may exclude (e.g., be free of) the uncoated portion 120 between 40 L and 100 L, or between 30 L and 100 L.

For example, the uncoated portion 120 may be positioned (e.g., arranged) only in a specific region of the electrode structure 1 so that crack formation within the electrode structure (e.g., jelly-roll type or kind electrode structure) 1 may be effectively prevented or reduced. Further, the electrode structure 1 may exclude (e.g., be free of) the uncoated portion 120 in a specific region so that a decrease in energy density due to the uncoated portion 120 included (e.g., introduced) in the electrode structure 1 may be effectively prevented or reduced. For example, a lithium secondary battery including the electrode structure (e.g., jelly-roll type or kind electrode structure) 1 may have excellent or suitable lifespan characteristics and capacity characteristics.

According to one or more embodiments, the electrode structure 1 may include at least one (e.g., about one to about five, or more) uncoated portions 120 and at least one (e.g., about one to about six, or more) coated portions 110. In some embodiments, the number of coated portions 110 may be at least one (e.g., one) greater than the number of uncoated portions 120. For example, if (e.g., when) the electrode structure 1 includes one uncoated portion 120, the electrode structure 1 may include two coated portions 110. For example, if (e.g., when) the electrode structure 1 includes two uncoated portions 120, the electrode structure 1 may include three coated portions 110. For example, if (e.g., when) the electrode structure 1 includes three uncoated portions 120, the electrode structure 1 may include four coated portions 110. For example, if (e.g., when) the electrode structure 1 includes four uncoated portions 120, the electrode structure 1 may include five coated portions 110. For example, if (e.g., when) the electrode structure 1 includes five uncoated portions 120, the electrode structure 1 may include six coated portions 110.

According to one or more embodiments, the electrode structure 1 may include one to three uncoated portions 120, or may include one to two uncoated portions 120.

For example, the coated portion 110 and the uncoated portion 120 may be alternatingly arranged in the longitudinal direction (e.g., “L”), of the electrode structure 1. For example, the coated portion 110 may be positioned (e.g., arranged) on 0 L and 100 L in the longitudinal direction of the electrode structure 1, while the uncoated portion 120 is positioned (e.g., arranged) between the coated portions 110. For example, the coated portion 110, the uncoated portion 120, the coated portion 110, the uncoated portion 120, and the coated portion 110 may be sequentially arranged, in the longitudinal direction of the electrode structure 1.

Referring to FIGS. 1 and 2, the coated portion 110 may include a first coated portion 111 and a second coated portion 113. For example, the electrode structure 1 may include one uncoated portion 120. For example, the electrode structure 1 may include the first coated portion 111, the uncoated portion 120, and the second coated portion 113.

According to one or more embodiments, the first coated portion 111, the uncoated portion 120, and the second coated portion 113 may be sequentially arranged in the longitudinal direction (e.g., “L”) of the electrode structure. For example, the first coated portion 111, the uncoated portion 120, and the second coated portion 113 in the electrode structure may be sequentially arranged in a direction from 0 L to 100 L. In this case, the uncoated portion 120 may be positioned (e.g., arranged) between 0 L and 50 L, between 0 L and 40 L, between 0 L and 30 L, or between 10 L and 30 L, in the electrode structure 1.

According to one or more embodiments, the uncoated portion 120 may have a width of about 1 (mm) to about 15 mm. For example, the uncoated portion 120 may have a width of about 2 mm to about 15 mm, about 3 mm to about 15 mm, or about 5 mm to about 15 mm.

According to one or more embodiments, the uncoated portion 120 may include a first uncoated portion 121 and a second uncoated portion 123, and the coated portion 110 may include a first coated portion 111, a second coated portion 113, and a third coated portion 115. In such a case, the first coated portion 111, the first uncoated portion 121, the second coated portion 113, the second uncoated portion 123, and the third coated portion 115 may be sequentially arranged in the longitudinal L direction (e.g. “L”), of the electrode structure 1.

Referring to FIG. 4, if (e.g., when) the electrode structure 1 includes two uncoated portions 120 (e.g., the first uncoated portion 121 and the second uncoated portion 123), and three coated portions 110 (e.g., the first coated portion 111, the second coated portion 113, and the third coated portion 115), the first coated portion 111, the first uncoated portion 121, the second coated portion 113, the second uncoated portion 123, and the third coated portion 115 may be sequentially arranged in the longitudinal L direction (e.g., “L”), of the electrode structure 1.

According to one or more embodiments, the width of the first uncoated portion 121 may be equal to the width of the second uncoated portion 123. For example, if (e.g., when) the width of the first uncoated portion 121 is the same as the width of the second uncoated portion 123, the durability of the electrode structure 1 may improve so that crack formation in the internal region of the electrode structure 1 can be more effectively prevented or reduced.

According to one or more embodiments, the first uncoated portion 121 may be positioned (e.g., arranged) between 0 L and 20 L in the electrode structure 1, and the second uncoated portion 123 may be positioned (e.g., arranged) between 20 L and 40 L in the electrode structure 1. For example, the first uncoated portion 121 and the second uncoated portion 123 may both (e.g., simultaneously) be positioned (e.g., arranged) between 0 L and 30 L in the electrode structure 1.

According to one or more embodiments, the electrode structure 1 may exclude an (e.g., be free of any) insulator. For example, by not including an insulator in the electrode structure 1, a decrease in the energy density of the electrode structure 1 due to an insulator may be effectively prevented or reduced. In this regard, a lithium secondary battery including the electrode structure 1 may have excellent or suitable capacity characteristics.

According to one or more embodiments, the electrode structure 1 may have a winding structure or a stack-winding structure. For example, the winding structure may refer to a form in which the electrode structure 1 is wound in one direction, as shown in FIG. 1. For example, the winding structure may be a form in which the electrode structure 1 is wound in one direction from 0 L, (i.e., a region or part where the winding of the electrode structure 1 starts), to 100 L, (i.e., a region or part where the winding of the electrode structure 1 concludes or ends), as shown in FIG. 1. For example, the stack-winding structure may be a form, as shown in FIG. 3, in which the electrode structure 1 is stacked in a zig-zag pattern at the starting point of the winding, and thereafter is wound in one direction. For example, in the stack-winding structure, as shown in FIG. 3, the portion of the electrode structure 1 that includes the uncoated portion 120 (i.e., the region from 0 L where the winding starts to 50 L) may be stacked in a zig-zag pattern, while the remaining portion of the electrode structure 1 (e.g., the region from 50 L to 100 L) is wound in one direction.

### Cathode 10

For example, the cathode 10 may include a cathode current collector and the cathode active material layer positioned (e.g., arranged) on the cathode current collector. For example, the cathode 10 may include a cathode current collector. For example, the cathode 10 may be prepared by providing the cathode active material layer on the cathode current collector.

For example, the cathode 10 may include a coated portion 110 in which the cathode active material layer is positioned (e.g., arranged), and an uncoated portion 120 in which the cathode active material layer is not provided (e.g., absent). For example, the coated portion 110 and the uncoated portion 120 in the cathode 10 may be alternatively arranged.

### Cathode: Cathode Current Collector

For example, the cathode current collector may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

According to one or more embodiments, the cathode current collector may include Al.

According to one or more embodiments, the cathode current collector may include, for example, a base film and a metal layer arranged on a side (e.g., one side or both sides (e.g., opposite sides or surfaces)) of the base film. For example, the base film may include a polymer. For example, the polymer may be a thermoplastic polymer. For example, the polymer may include polyethylene terephthalate (PET), polyethylene (PE), polypropylene (PP), polybutylene terephthalate (PBT), polyimide (PI), and/or a (e.g., any suitable) combination thereof. Because the base film includes a thermoplastic polymer, the base film may be liquefied in the event of a short circuit, thereby preventing or reducing a sudden increase in current. For example, the base film may be an insulator. For example, the metal layer may include indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. In the event of an overcurrent, the metal layer may be disconnected, thus acting as an electrochemical fuse to provide protection against short circuits. A limiting current and a maximum current of cathode current collector may be controlled or selected through controlling the thickness of the metal layer. The metal layer may be plated or deposited on the base film. Because the limiting current and/or maximum current of the cathode current collector decrease if (e.g., when) the thickness of the metal layer decreases, the stability of the lithium battery during a short circuit may improve. A lead-tab may be added on the metal layer for connection to the outside. The lead-tab may be welded to the metal layer or a metal layer/base film laminate by ultrasonic welding, laser welding, spot welding, and/or the like. As the base film and/or the metal layer melt during welding, the metal layer may be electrically connected to the lead-tab. For stronger welding between the metal layer and the lead-tab, a metal chip may be added between the metal layer and the lead-tab. The metal chip may be a flake of the same material as the metal of the metal layer. For example, the metal chip may be a metal foil, a metal mesh, and/or the like. For example, the metal chip may be an aluminum foil, a copper foil, a stainless steel (SUS) foil, and/or the like. By welding the metal layer with the lead-tab after placing the metal chip on the metal layer, the lead-tab may be welded to a metal chip/metal layer laminate or a metal chip/metal layer/base film laminate. As the base film, the metal layer, and/or the metal chip melt during welding, the metal layer or the metal layer/metal chip laminate may be electrically connected to the lead-tab. A metal chip and/or a lead-tab may be added on a portion of the metal layer. For example, the base film may have a thickness of about 1 μm to about 50 μm, about 1.5 μm to about 50 μm, about 1.5 μm to about 40 μm, or about 1 μm to about 30 μm. With the base film having a thickness within the described ranges, the weight of the cathode current collector may be more effectively reduced. For example, the base film may have a melting point of about 100° C. to about 300° C., about 100° C. to about 250° C. or less, or about 100° C. to about 200° C. Because the base film has a melting point within the aforementioned ranges, the base film may easily melt and be bonded to the lead-tab while welding the lead-tab. To improve adhesion between the base film and the metal layer, a surface treatment, such as corona treatment, may be performed on the base film. For example, the metal layer may have a thickness of about 0.01 μm to about 3 μm, about 0.1 μm to about 3 μm, about 0.1 μm to about 2 μm, or about 0.1 μm to about 1 μm. With the metal layer having a thickness within the described ranges, the electrode structure may provide stability while maintaining conductivity. For example, the metal chip may have a thickness of about 2 μm to about 10 μm, about 2 μm to about 7 μm, or about 4 μm to about 6 μm. With the metal chip having a thickness within the described ranges, connecting the metal layer and the lead-tab to each other may be more easily performed. With the cathode current collector 210 having the aforementioned structure, the electrode may have a reduced weight and thus, improved energy density.

### Cathode: Cathode Active Material Layer

The cathode active material layer may include a cathode active material, a conductive material (e.g., electron conductor), and a binder.

For example, the cathode active material may utilize one or more composite oxides of lithium with a metal selected from among cobalt, manganese, nickel, and/or a (e.g., any suitable) combination thereof. For example, the cathode active material may utilize any one compound represented by the following formulas: LiₐA_{1-b}B¹_{b}D¹₂ (in the formula, 0.90≤a≤1.8, and 0≤b≤0.5); LiₐE_{1-b}B¹_{b}O_{2-c}D¹_{c} (in the formula, 0.90≤a≤1.8, 0≤b≤0.5, and 0≤c≤0.05); LiE_{2-b}B¹_{b}O_{4-c}D¹_{c} (in the formula, 0≤b≤0.5 and 0≤c≤0.05); LiₐNi_{1-b-c}Co_{b}B¹_{c}D¹_{α} (in the formula, 0.90≤a≤1.8, 0≤b≤0.5, 0≤c≤0.05, and 0<α≤2); LiₐNi_{1-b-c}CO_{b}B¹_{c}O_{2-α}F¹_{α} (in the formula, 0.90≤a≤1.8, 0≤b≤0.5, 0≤c≤0.05, and 0<α<2); LiₐNi_{1-b-c}Co_{b}B¹_{c}O_{2-α}F¹₂ (in the formula, 0.90≤a≤1.8, 0≤b≤0.5, 0≤c≤0.05, and 0<α<2); LiₐNi_{1-b-c}Mn_{b}B¹_{c}D_{α} (in the formula, 0.90≤a≤1.8, 0≤b≤0.5, 0≤c≤0.05, and 0<α≤2); LiₐNi_{1-b-c}Mn_{b}B¹_{c}O_{2-α}F¹_{α} (in the formula, 0.90≤a≤1.8, 0≤b≤0.5, 0≤c≤0.05, and 0<α<2); LiₐNi_{1-b-c}Mn_{b}B¹_{c}O_{2-α}F¹₂ (in the formula, 0.90≤a≤1.8, 0≤b≤0.5, 0≤c≤0.05, and 0<α<2); LiₐNi_{b}E_{c}G_{d}O₂ (in the formula, 0.90≤a≤1.8, 0≤b≤0.9, 0≤c≤0.5, and 0.001≤d≤0.1); LiₐNi_{b}Co_{c}Mn_{d}GeO₂ (in the formula, 0.90≤a≤1.8, 0≤b≤0.9, 0≤c≤0.5, 0≤d≤0.5, and 0.001≤e≤0.1); LiₐNiG_{b}O₂ (in the formula, 0.90≤a≤1.8, and 0.001≤b≤0.1); LiₐCoG_{b}O₂ (in the formula, 0.90≤a≤1.8, and 0.001≤b≤0.1); LiₐMnG_{b}O₂ (in the formula, 0.90≤a≤1.8, and 0.001≤b≤0.1); LiₐMn₂G_{b}O₄ (in the formula, 0.90≤a≤1.8, and 0.001≤b≤0.1); QO₂; QS₂; LiQS₂; V₂O₅; LiV₂O₅; LiIO₂; LiNiVO₄; Li_{(3-f)}J2(PO₄)₃ (0≤f≤2); Li_{(3-f)}Fe₂(PO₄)₃ (0≤f≤2); and LiFePO₄.

In the formulas described, A may be nickel (Ni), cobalt (Co), manganese (Mn), and/or a (e.g., any suitable) combination thereof; B¹ may be Al, Ni, Co, Mn, Cr, Fe, Mg, Sr, V, Ga, Si, W, Mo, Cu, Zn, Ti, boron (B), a rare earth element, and/or a (e.g., any suitable) combination thereof; D¹ may be oxygen (O), fluorine (F), sulfur(S), phosphorus (P), and/or a (e.g., any suitable) combination thereof; E may be Co, Mn, and/or a (e.g., any suitable) combination thereof; F¹ may be F, S, P, Cl, Br, and/or a (e.g., any suitable) combination thereof; G may be Al, Cr, Mn, Fe, Mg, lanthanum (La), cerium (Ce), Sr, V, and/or a (e.g., any suitable) combination thereof; Q may be titanium (Ti), molybdenum (Mo), Mn, and/or a (e.g., any suitable) combination thereof; I may be Cr, V, Fe, Sc, yttrium (Y), and/or a (e.g., any suitable) combination thereof; and J may be V, Cr, Mn, Co, Ni, copper (Cu), and/or a (e.g., any suitable) combination thereof.

For example, the cathode active material may include a lithium transition metal oxide including nickel and other transition metals. In the lithium transition metal oxide including nickel and other transition metals, the amount of nickel may be 60 mol % or more, for example, 75 mol % or more, for example, 80 mol % or more, for example, 85 mol % or more, or for example, 90 mol % or more, with respect to the total number of moles of the transition metals.

For example, the lithium transition metal oxide may be a compound represented by Formula 1:

Formula 1

LiₐNiₓCo_{y}M_{z}O_{2-b}A_{b}

In Formula 1, the relations 1.0≤a≤1.2, 0≤b≤0.2, 0.6≤x<1, 0≤y≤0.3, 0<z≤0.3, and x+y+z=1 may be satisfied, M may be one or more selected from among manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and

A may be F, S, Cl, Br and/or a (e.g., any suitable) combination thereof.

In Formula 1, for example, the relations 0.7≤x<1, 0<y≤0.3, 0<z≤0.3; 0.8≤x<1, 0<y≤0.3, and 0<z≤0.3; 0.8≤x<1, 0<y≤0.2, 0<z≤0.2; 0.83≤x<0.97, 0<y≤0.15, and 0<z≤0.15; or 0.85≤x<0.95, 0<y≤0.1, and 0<z≤0.1, may be satisfied.

For example, the lithium transition metal oxide may be at least one compound represented by Formulas 1-1 and 1-2:

Formula 1-1

LiNiₓCo_{y}Mn_{z}O₂

In Formula 1-1, the relations 0.6≤x≤0.95, 0<y≤0.2, and 0<z≤0.1 may be satisfied. For example, the relations 0.7≤x≤0.95, 0<y≤0.3, and 0<z≤0.3 may be satisfied.

Formula 1-2

LiNiₓCo_{y}Al_{z}O₂

In Formula 1-2, the relations 0.6≤x≤0.95, 0<y≤0.2, and 0<z≤0.1 may be satisfied. For example, the relations 0.7≤x≤0.95, 0<y≤0.3, and 0<z≤0.3 may be satisfied. For example, the relations 0.8≤x≤0.95, 0<y≤0.3, and 0<z≤0.3 may be satisfied. For example, the relations 0.82≤x≤0.95, 0<y≤0.15, and 0<z≤0.15 may be satisfied. For example, the relations 0.85≤x≤0.95, 0<y≤0.1, and 0<z≤0.1 may be satisfied.

For example, the lithium transition metal oxide may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.8}Co_{0.1}Mn_{0.2}O₂, or LiNi_{0.88}Co_{0.1}Al_{0.02}O₂.

For example, the cathode active material may utilize a compound having a coating layer on the surface of the lithium transition metal oxide, or may utilize a mixture of the lithium transition metal oxide with a lithium transition metal oxide having a coating layer.

For example, the coating layer may include a compound of a coating element, such as oxides and hydroxides of the coating element, oxyhydroxides of the coating element, oxycarbonates of the coating element, and hydroxycarbonates of the coating element.

For example, the compound providing the coating layer may be amorphous or crystalline. The coating element included in the coating layer may include Mg, Al, Co, K, Na, Ca, Si, Ti, V, Sn, Ge, Ga, B, As, Zr, and/or a (e.g., any suitable) mixture (e.g., combination) thereof. The coating layer may be formed through a process in which the coating elements are coated on the lithium transition metal oxide by a coating method that does not have an adverse effect on the physical properties of the cathode active materials (for example, spray coating, dip coating, and/or the like). The coating may be performed by any available coating method, and because such coating methods are well suitable to those skilled in the art, details of such methods will not be described in further detail.

The conductive material may utilize carbon black, graphite microparticles, and/or the like; but without being limited to the aforementioned examples, any conductive material available in the art may be utilized.

Examples of the binder may include a vinylidene fluoride/hexafluoropropylene copolymer, polyvinylidene fluoride (PVDF), polyacrylonitrile, polymethylmethacrylate, polytetrafluoroethylene, a mixture of the aforementioned polymers, a styrene butadiene-rubber polymer, and/or the like; however, the binder is not limited to the aforementioned examples and may be any and all binders available in the art.

### Anode 20

According to one or more embodiments, the anode 20 may include an anode current collector, and the anode active material layer positioned (e.g., arranged) on the anode current collector.

For example, the anode 20 may include a coated portion 110 in which the anode active material layer is positioned (e.g., arranged), and an uncoated portion 120 in which the anode active material layer is not provided (e.g., absent). For example, the coated portion 110 and the uncoated portion 120 in the anode 20 may be alternatingly arranged.

### Anode Current Collector

For example, the anode current collector may include indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), or an alloy thereof.

For example, the anode current collector may utilize any one selected from among copper foil, nickel foil, stainless steel foil, titanium foil, nickel foam, copper foam, a polymer substrate coated with a conductive metal, and/or a (e.g., any suitable) combination thereof. According to one or more embodiments, the anode current collector may include copper or stainless steel.

According to one or more embodiments, the anode current collector may include, for example, a base film and a metal layer arranged on a side (e.g., one side or both sides (e.g., opposite sides or surfaces)) of the base film. For example, the base film may include a polymer. For example, the polymer may be a thermos plastic polymer. For example, the polymer may include polyethylene terephthalate (PET), polyethylene (PE), polypropylene (PP), polybutylene terephthalate (PBT), polyimide (PI), and/or a (e.g., any suitable) combination thereof. Because the base film includes a thermoplastic polymer, the base film may be liquefied in the event of a short circuit, thereby preventing or reducing a sudden increase in current. For example, the base film may be an insulator. For example, the metal layer may include indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. In the event of an overcurrent, the metal layer may be disconnected, thus acting as a fuse (e.g., an electrochemical fuse) to provide protection against short circuits. A limiting current and a maximum current may be controlled or selected through controlling the thickness of the metal layer. The metal layer may be plated or deposited on the base film. Because the limiting current and/or maximum current of the cathode current collector decrease if (e.g., when) the thickness of the metal layer decreases, the stability of the lithium battery during a short circuit may improve. A lead-tab may be added on the metal layer for connection to the outside. The lead-tab may be welded to the metal layer or a metal layer/base film laminate by ultrasonic welding, laser welding, spot welding, and/or the like. As the base film and/or the metal layer melt during welding, the metal layer may be electrically connected to the lead-tab. For stronger welding between the metal layer and the lead-tab, a metal chip may be added between the metal layer and the lead-tab. The metal chip may be a flake of the same material as the metal of the metal layer. For example, the metal chip may be a metal foil, a metal mesh, and/or the like. For example, the metal chip may be an aluminum foil, a copper foil, a stainless steel (SUS) foil, and/or the like. By welding the metal layer with the lead-tab after placing the metal chip on the metal layer, the lead-tab may be welded to a metal chip/metal layer laminate or a metal chip/metal layer/base film laminate. As the base film, the metal layer, and/or the metal chip melt during welding, the metal layer or the metal layer/metal chip laminate may be electrically connected to the lead-tab. A metal chip and/or a lead-tab may be further added on a part of the metal layer. For example, the base film may have a thickness of about 1 micrometer (μm) to about 50 μm, about 1.5 μm to about 50 μm, about 1.5 μm to about 40 μm, or about 1 μm to about 30 μm. With the base film having a thickness within the described ranges, the weight of the cathode current collector may be more effectively decreased or reduced. For example, the base film may have a melting point of about 100° C. to about 300° C., about 100° C. to about 250° C. or less, or about 100° C. to about 200° C. Because the base film has a melting point within the aforementioned ranges, the base film may easily melt and be bonded to the lead-tab while welding the lead-tab. To improve adhesion between the base film and the metal layer, a surface treatment, such as corona treatment, may be performed on the base film. For example, the metal layer may have a thickness of about 0.01 μm to about 3 μm, about 0.1 μm to about 3 μm, about 0.1 μm to about 2 μm, or about 0.1 μm to about 1 μm. With the metal layer having a thickness within the aforementioned ranges, the electrode structure may provide stability while maintaining conductivity. For example, the metal chip may have a thickness of about 2 μm to about 10 μm, about 2 μm to about 7 μm, or about 4 μm to about 6 μm. With the metal chip having a thickness within the described ranges, connecting the metal layer and the lead-tab to each other may be more easily performed. With the cathode current collector 210 having the aforementioned structure, the electrode may have a reduced weight and thus, improved energy density.

### Anode Active Material Layer

The anode active material layer may include an anode active material and may further include a binder and/or a conductive material.

For example, the anode active material layer may include about 90 wt % to about 99 wt % of an anode active material, about 0.5 wt % to about 5 wt % of a binder, and about 0 wt % to about 5 wt % of a conductive material.

The binder may serve to ensure adhesion between anode active material particles, and also to ensure adhesion of the anode active material to current collectors. Examples of the binder may include a nonaqueous binder, an aqueous binder, a dry binder, and/or a (e.g., any suitable) combination thereof.

Examples of the nonaqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

Examples of the aqueous binder may include, styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene-diene copolymer, polyvinylpyridine, chlorosulfonated polyethylene, latex, polyester resin, (meth)acrylic resin, phenol resin, epoxy resin, polyvinyl alcohol, and/or a (e.g., any suitable) combination thereof.

If an aqueous binder is used as binder for the anode, a cellulose-based compound capable of imparting viscosity may be further included. As the cellulose-based compound, a mixture of one or more selected from among carboxymethyl cellulose, hydroxypropylmethyl cellulose, methyl cellulose, and alkali metal salts thereof, may be used. As the alkali metal, Na, K, or Li may be used.

The dry binder may be a polymer material that can be fibrillated and may include, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material is used to impart conductivity to an electrode, and may be any electronically conductive material that does not cause a chemical change in a battery in which the corresponding conductive material is to be included. Examples of the conductive material may include: carbon-based materials, such as natural graphite, artificial graphite, carbon black, acetylene black, Ketjen black, carbon fibers, carbon nanofibers, and carbon nanotubes; metal-based materials in the form of metal powder or metal fibers, containing copper, nickel, aluminum, silver, and/or the like; conductive polymers, such as polyphenylene derivatives; and/or a (e.g., any suitable) mixture of the aforementioned examples.

### Separator 30

For example, the separator 30 may be positioned (e.g., arranged) between the cathode 10 and the anode 20.

For example, as the separator 40, polyethylene, polypropylene, polyvinylidene fluoride, or a multi-layer thereof (two or more layers) may be used. For example, a mixed multi-layer, such as a two-layer separator of polyethylene/polypropylene, a three-layer separator of polyethylene/polypropylene/polyethylene, a three-layer separator of polypropylene/polyethylene/polypropylene, and/or the like may be used.

The separator 30 may include a porous substrate and a coating layer positioned (e.g., arranged) on a side (e.g., one side or both sides (e.g., opposite sides or surfaces)) of the porous substrate, the coating layer including an organic material, an inorganic material, and/or a (e.g., any suitable) combination thereof.

The porous substrate may be a polymer film formed of: any one polymer selected from among polyolefins such as polyethylene and polypropylene, polyesters such as polyethylene terephthalate and polybutylene terephthalate, polyacetal, polyamide, polyimide, polycarbonate, polyether ketone, polyaryl ether ketone, polyetherimide, polyamide-imide, polybenzimidazole, polyethersulfone, polyphenylene oxide, cyclic olefin copolymers, polyphenylene sulfide, polyethylene naphthalate, glass fibers, Teflon, and polytetrafluoroethylene; or a copolymer and/or a (e.g., any suitable) mixture of two or more of the aforementioned polymers.

The organic material may include a polyvinylidene fluoride-based polymer or a (meth)acryl-based polymer.

The inorganic material may include, but the present disclosure is not limited thereto, inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof.

The organic material and the inorganic material may be present together in a mixed state in one coating layer, or may be present in the form of where a coating layer including the organic material and a coating layer including the inorganic material are laminated.

### Lithium Secondary Battery

According to one or more embodiments, a lithium secondary battery including the aforementioned electrode structure may be provided.

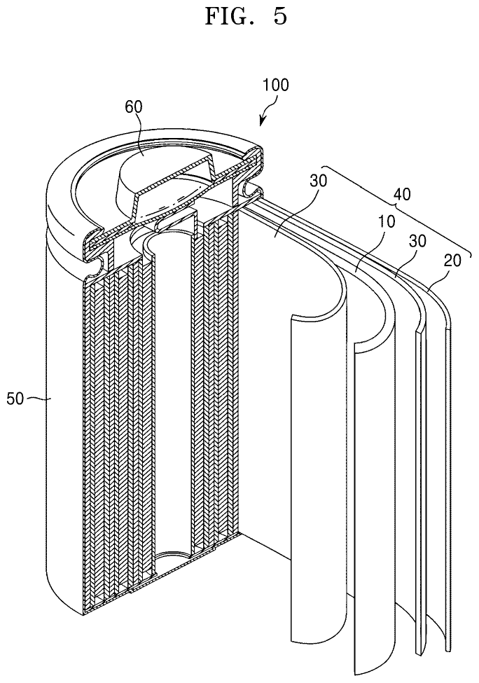

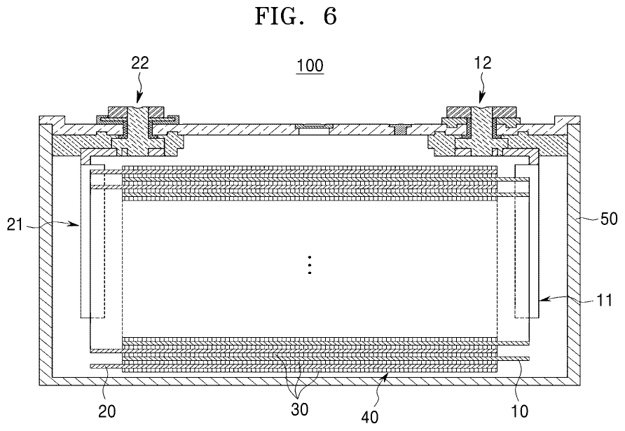

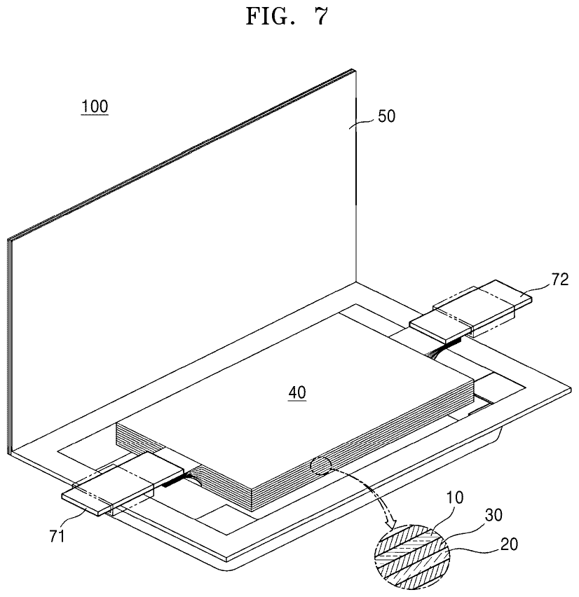

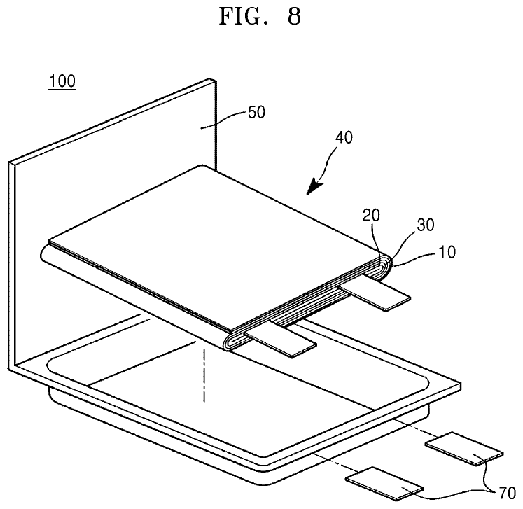

The lithium secondary battery, depending on its form, may be classified into a cylindrical-type or kind, a prismatic-type or kind, a pouch-type or kind, a coin-type or kind, and/or the like. FIGS. 5 to 8 are schematic diagrams, each illustrating a lithium secondary battery according to one or more embodiments. FIG. 5 illustrates a cylindrical-type or kind battery, FIG. 6 illustrates a prismatic-type or kind battery, and FIGS. 7 and 8 illustrate a pouch-type or kind battery.

Referring to FIGS. 5 to 8, a lithium secondary battery 100 may include: an electrode structure 40 in which a separator 30 is positioned (e.g., arranged) between a cathode 10 and an anode 20; and a case 50 in which the electrode structure 40 is built-in. The electrode structure 40 may include the aforementioned electrode structure.

The cathode 10, the anode 20, and the separator 30 may be impregnated with an electrolyte.

The lithium secondary battery 100 may be include a sealing element 60 that seals the 50 as shown in FIG. 5. For example, as shown in FIG. 6, the lithium secondary battery 100 may include a cathode lead-tab 11, a cathode terminal 12, an anode lead-tab 21, and an anode terminal 22. As shown in FIGS. 7 and 8, the lithium secondary battery 100 may include electrode tabs 70, for example, a cathode tab 71 and an anode tab 72, which act as an electrical path to guide an electrical current formed in the electrode structure 40 to the outside.

### Electrolyte

According to one or more embodiments, the electrolyte may be, for example, a liquid electrolyte, a solid electrolyte, a gel electrolyte, and/or a (e.g., any suitable) combination thereof.

The electrolyte may be, for example, an organic electrolyte solution. The organic electrolyte solution may be prepared by, for example, dissolving a lithium salt in an organic solvent.

For the organic solvent, any organic solvent available in the art may be used. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, and/or a (e.g., any suitable) mixture (e.g., combination) thereof.

The lithium salt may be any lithium salt available in the art. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂) (C_{y}F_{2y+1}SO₂) (1≤x≤20 and 1≤y≤20), LiCl, LiI, and/or a (e.g., any suitable) mixture (e.g., combination) thereof. The concentration of the lithium salt may be, for example, about 0.1 M to about 5.0 M.

The solid electrolyte may be, for example, an oxide-based solid electrolyte, a sulfide-based solid electrolyte, a polymer solid electrolyte, and/or a (e.g., any suitable) combination thereof.

The solid electrolyte may be, for example, an oxide-based solid electrolyte. The oxide-based solid electrolyte may be one or more selected from among Li_{1+x+y}AlₓTi₂₋ₓSi_{y}P_{3-y}O₁₂ (0<x<2 and 0≤y<3), BaTiO₃, Pb(Zr,Ti)O₃ (PZT), Pb₁₋ₓLaₓZr_{1-y}TiyO₃ (PLZT) (0≤x<1 and 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1, and 0<z<3), Li_{1+x+y}(Al, Ga)ₓ(Ti, Ge)₂₋ₓSi_{y}P_{3-y}O₁₂ (0≤x≤1 and 0≤y≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (wherein M=Te, Nb, or Zr, and x is an integer of 1 to 10). The solid electrolyte may be produced by methods such as a sintering method. For example, the oxide-based solid electrolyte may be a garnet-type or kind solid electrolyte selected from among Li₇La₃Zr₂O₁₂ (LLZO) and Li₃₊ₓLa₃Zr₂₋ₐMₐO₁₂ (M-doped LLZO, wherein M=Ga, W, Nb, Ta, or Al, x is an integer of 1 to 10, and 0<a<2).

Examples of the sulfide-based solid electrolyte may include lithium sulfide, silicon sulfide, phosphorus sulfide, boron sulfide, and/or a (e.g., any suitable) combination thereof. Sulfide-based solid electrolyte particles may include Li₂S, P₂S₅, SiS₂, GeS₂, B₂S₃, and/or a (e.g., any suitable) combination thereof. The sulfide-based solid electrolyte particles may be Li₂S or P₂S₅. The sulfide-based solid electrolyte particles are suitable to have a higher lithium-ion conductivity than other inorganic compounds. For example, the sulfide-based solid electrolyte may include Li₂S and P₂S₅. If (e.g., when) the sulfide solid electrolyte materials constituting the sulfide-based solid electrolyte include Li₂S—P₂S₅, the mixing molar ratio of Li₂S and P₂S₅ may be, for example, in a range of about 50:50 to about 90:10. For example, a material such as Li₃PO₄, a halogen, a halogen compound, Li₂₊₂ₓZn₁₋ₓGeO₄ (“LISICON”, 0≤x<1), Li_{3+y}PO₄₋ₓNₓ (“LIPON”, 0<x<4 and 0<y<3), Li_{3.25}Ge_{0.25}P_{0.75}S₄ (“Thio-LISICON”), and Li₂O—Al₂O₃—TiO₂—P₂O₅ (“LATP”), may be added to an inorganic solid electrolyte, such as Li₂S—P₂S₅, SiS₂, GeS₂, B₂S₃, and/or a (e.g., any suitable) combination thereof, to prepare an inorganic solid electrolyte, and this inorganic solid electrolyte may be used as a sulfide-based solid electrolyte. Non-limiting examples of the sulfide solid electrolyte materials may include Li₂S—P₂S₅; Li₂S—P₂S₅—LiX (X=a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (wherein 0<m<10, 0<n<10, and Z=Ge, Zn or Ga); Li₂S—GeS₂; Li₂S—SiS₂—Li₃PO₄; and Li₂S—SiS₂-LiₚMO_{q} (wherein 0<p<10, 0<q<10, and M=P, Si, Ge, B, Al, Ga or In). In this regard, the sulfide-based solid electrolyte material may be prepared by subjecting a starting material (e.g., Li₂S, P₂S₅, and/or the like) of the sulfide-based solid electrolyte material to a treatment, such as melt quenching, mechanical milling, and/or the like. A calcination process may be performed following the described treatment. The sulfide-based solid electrolyte may be amorphous or crystalline, or may be in a mixed state between amorphous and crystalline.

For example, the polymer solid electrolyte may be an electrolyte that includes a mixture of a lithium salt and a polymer, or includes a polymer having an ion-conducting functional group. The polymer solid electrolyte may be, for example, a polymer electrolyte that does not contain liquid electrolytes. Examples of the polymer included in the polymer solid electrolyte may include polyethylene oxide (PEO), polyvinylidene fluoride (PVDF), vinylidene fluoride-hexafluoropropylene (PVDF-HFP), a poly(styrene-b-ethylene oxide) block copolymer (PS-PEO), poly(styrene-butadiene), poly(styrene-isoprene-styrene), a poly(styrene-b-divinylbenzene) block copolymer, a poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylenedioxythiophene (PEDOT), polypyrrole (PPY), polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone (SPAEKKS), sulfonated poly(aryl ether ketone (SPAEK), poly[bis(benzimidazobenzisoquinolinones)] (SPBIBI), poly(styrene sulfonate) (PSS), and lithium 9,10-diphenylanthracene-2-sulfonate (DPASLi+), and/or a (e.g., any suitable) combination thereof. However, the polymer is not limited to the aforementioned examples and may be any polymer electrolyte available in the art. The lithium salt may be any lithium salt available in the art. The lithium salt may include one or more selected from among, for example, LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSl), LiC₄F₉SO₃, LiN(CₓF₂ₓ₊₁SO₂)(CyF_{2y+1}SO₂) (wherein x and y are each an integer of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The gel electrolyte may be, for example, a gel polymer electrolyte. The gel polymer electrolyte may be an electrolyte that includes, for example, a liquid electrolyte and a polymer, or includes an organic solvent and a polymer having an ion-conducting functional group. For example, the liquid electrolyte may be a mixture of an ionic liquid, a lithium salt, and an organic solvent; a mixture of an ionic liquid and an organic solvent; and/or a (e.g., any suitable) mixture of a lithium salt, an ionic liquid, and an organic solvent. The polymer may be selected from among the polymers used in the solid polymer electrolyte. The organic solvent may be selected from among the organic solvents used in the liquid electrolyte. The lithium salt may be selected from among the lithium salts used in the solid polymer electrolyte. The ionic liquid may refer to a room-temperature molten salt or a salt that is in a liquid state at room temperature, which only includes (e.g., consists of) ions and has a melting point of room temperature or less. For example, the ionic liquid may be at least one selected from among compounds containing: a) at least one cation selected from among ammonium, pyrrolidinium, pyridinium, pyrimidinium, imidazolium, piperidinium, pyrazolium, oxazolium, pyridazinium, phosphonium, sulfonium, triazolium, and/or a (e.g., any suitable) mixture thereof; and b) at least one anion selected from among BF₄⁻, PF₆⁻, AsF₆⁻, SbF₆⁻, AlCl₄⁻, HSO₄⁻, ClO₄⁻, CH₃SO₃⁻, CF₃CO₂⁻, Cl, Br, I, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. For example, the polymer solid electrolyte may be impregnated with an electrolyte solution in a lithium battery to form a gel polymer electrolyte. The gel electrolyte may further include inorganic particles.

A lithium secondary battery according to one or more embodiments of the present disclosure may be applied to automobiles, mobile phones, and/or one or more suitable types (kinds) of electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinbelow, embodiments will be described in greater detail with reference to the accompanied drawings; however, the present disclosure is not limited to these examples. While one or more embodiments have been described with reference to the drawings, it will be understood by those of ordinary skill in the art that one or more suitable changes in form and details may be made therein without departing from the spirit and scope of the present disclosure as defined by the following claims and equivalents thereof.

Hereinbelow, Examples and Comparative Examples of the present disclosure will be described. However, it should be understood that the following examples are an example of the present disclosure, and that the present disclosure is not limited to the following examples.

### EXAMPLES

### Example 1: Preparation of Lithium Secondary Battery

### Preparation of Cathode

A cathode composition was obtained by mixing LiNi_{0.6}Co_{0.2}Al_{0.2}O₂, a conductive material (Super-P; Timcal Ltd.), a binder (PVDF), and N-methylpyrrolidone. The mixing weight ratio of LiNi_{0.6}Co_{0.2}Al_{0.2}O₂, the conductive material, and the binder in the cathode composition was 97.5:1.5:1.

The cathode composition was applied on top of an aluminum foil (thickness: about 15 micrometer (μm)) such that the coated portion and the uncoated portion were arranged as shown in FIG. 2, and then was dried under vacuum at about 110° C. to prepare a cathode.

### Preparation of Anode

As an anode current collector, a 10 μm-thick Cu foil was prepared. Then, 5 wt % of an NMP solution of a PS-PEO-PS block copolymer (mixing weight ratio of PS-PEO-PS=12:59:12) (weight average molecular weight: about 83,000 Daltons) was added to carbon black and silver (Ag) (particle diameter: 60 nanometer (nm)) as anode active materials, to prepare a slurry. The mixing weight ratio of carbon black and silver (Ag) was 1:3, and the amount of the PS-PEO-PS block copolymer was about 5 parts by weight based on 100 parts by weight of the total weight of the anode active materials (the total weight of furnace black powder and silver). The NMP solution was added until the viscosity of the slurry was at a suitable state for film formation by a blade coater. This slurry was applied onto the Cu foil in such a way that a coated portion and an uncoated portion were positioned (e.g., arranged) as shown in FIG. 2, and then was vacuum-dried at 100° C. for 12 hours. Following the aforementioned process, an anode was prepared.

### Preparation of Electrode Structure

An electrode structure was prepared by using the cathode and the anode prepared described herein, and positioning a polyethylene separator between the anode and the cathode.

Then, the electrode structure was wound in one direction from 0 L to 100 L, to prepare a jelly-roll type or kind electrode structure having a winding structure as shown in FIG. 1.

### Preparation of Lithium Secondary Battery

A lithium battery (pouch cell) was prepared by immersing the electrode structure prepared described herein in an electrolyte, containing 1.3M LiPF₆ dissolved in ethylene carbonate (EC)+ethyl methyl carbonate (EMC)+dimethyl carbonate (DMC) having a volume ratio of 3:4:3.

### Example 2: Preparation of Lithium Secondary Battery

A lithium secondary battery was prepared following substantially the same process as Example 1, except that the anode active material layer and the cathode active material layer were positioned (e.g., arranged) differently from those in Example 1. The uncoated portion and the coated portion were formed as shown in FIG. 4, and when winding the electrode structure, as shown in FIG. 3, the electrode structure was stacked in a zig-zag pattern from 0 L to 40 L with the uncoated portion wound in one direction from 40 L to 100 L, so as to form a jelly-roll type or kind electrode structure.

### Comparative Example 1: Preparation of Lithium Secondary Battery

A lithium secondary battery was prepared following substantially the same process as Example 1, except that unlike Example 1, the anode active material layer and the cathode active material layer were formed without including uncoated portions.

### Comparative Example 2: Preparation of Lithium Secondary Battery

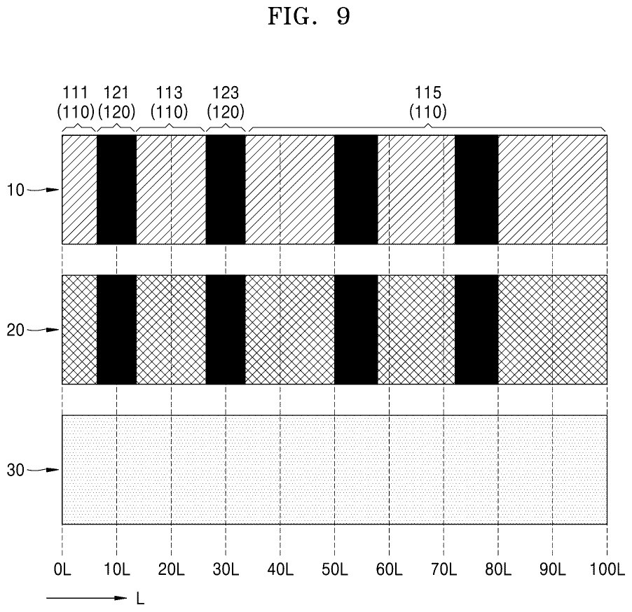

A lithium secondary battery including an electrode structure having a winding structure was prepared following substantially the same process as Example 1, except that the anode active material layer and the cathode active material layer were positioned (e.g., arranged) differently from those in Example 1 such that the uncoated portion and the coated portion were formed as shown in FIG. 9.

### Comparative Example 3: Preparation of Lithium Secondary Battery

A lithium secondary battery including an electrode structure having a stack-winding structure was prepared following substantially the same process as Example 2, except that the anode active material layer and the cathode active material layer were positioned (e.g., arranged) differently from those in Example 2 such that the uncoated portion and the coated portion were formed as shown in FIG. 9.

### Evaluation Example

The charge-discharge characteristics of each lithium secondary battery prepared in Examples 1 and 2 and Comparative Examples 1 to 3 were evaluated.

In the 1st cycle, the charging was performed at a constant current of 0.5 milliampere per square centimeter (mA/cm²) until the battery voltage reached 4.25 V, and the charging at a constant voltage of 4.25 V was performed until the current reached 0.2 mA. Subsequently, the discharging was performed at a constant current of 0.5 mA/cm² until the battery voltage reached 2.0 V. After the 2nd cycle, the charging was performed at a constant current of 2.5 mA/cm² until the battery voltage reached 4.25 V, and then the discharging was performed at a current density of 2.5 mA/cm². The charge-discharge test was performed with the secondary battery placed in a constant-temperature bath at 60° C.

During the charge-discharge test, the number of cracks formed in a battery after two charge-discharge cycles, and the initial capacity of the battery were measured, and are shown in Table 1.

TABLE 1

| | Arrangement | | Number | Battery |
|---|---|---|---|---|
| | of uncoated | | of cracks | capacity |
| | portion | Winding form | (ea) | (Ah) |
| Example 1 | FIG. 2 | Winding structure | 0 | 6.25 |
| | | (FIG. 1) | | |
| Example 2 | FIG. 4 | Stack-winding | 0 | 6.13 |
| | | structure | | |
| | | (FIG. 3) | | |
| Comparative | Not included | Winding structure | >10 | 6.0 |
| Example 1 | | | | |
| Comparative | FIG. 9 | Winding structure | 0 | 6.08 |
| Example 2 | | (FIG. 1) | | |
| Comparative | FIG. 9 | Stack-winding | 0 | 6.05 |
| Example 3 | | structure | | |
| | | (FIG. 3) | | |

Referring to Table 1, Examples 1 and 2 with the uncoated portion positioned (e.g., arranged) between 0 L and 50 L in the electrode structure each exhibited suppressed or reduced crack formation (e.g., no crack formation) and improved battery capacity, in comparison to Comparative Examples with the uncoated portion positioned (e.g., arranged) between 50 L and 100 L, or Comparative Examples without uncoated portion.

According to an aspect of the present disclosure, the electrode structure includes a coated portion and an uncoated portion, wherein the uncoated portion is positioned (e.g., arranged) in a specific location so that crack formation in the electrode structure can be effectively prevented or reduced.

Further, as the uncoated portion is positioned (e.g., arranged) in a specific location in the electrode structure, a lithium secondary battery including the electrode structure may have excellent or suitable energy density.

A battery manufacturing device, a management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the battery may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the battery may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

In the context of the present application and unless otherwise defined, the terms “use,” “using,” and “used” may be considered synonymous with the terms “utilize,” “utilizing,” and “utilized,” respectively.

A person of ordinary skill in the art, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It should be understood that embodiments described herein should be considered in a descriptive sense only and not for purposes of limitation. Descriptions of features or aspects within each embodiment should typically be considered as available for other similar features or aspects in one or more embodiments. While one or more embodiments have been described with reference to the drawings, it will be understood by those of ordinary skill in the art that one or more suitable changes in form and details may be made therein without departing from the spirit and scope of the present disclosure as defined by the following claims and equivalents thereof.

What is claimed is:

1. An electrode structure comprising:
a cathode comprising a cathode active material layer;
an anode comprising an anode active material layer;
a separator between the cathode and the anode;
at least one coated portion comprising the cathode active material layer or the anode active material layer;
at least one uncoated portion, each uncoated portion excluding the cathode active material layer and the anode active material layer;
a portion inside the electrode structure and defined as a 0 L location based on a longitudinal direction; and
a portion outside the electrode structure and defined as a 100 L location based on the longitudinal direction,
wherein the electrode structure comprises the uncoated portion between the 0 L location and a 50 L location, and excludes the uncoated portion between the 50 L location and the 100 L location, and
wherein the electrode structure has a jelly-roll electrode structure.

2. The electrode structure as claimed in claim 1,
wherein the electrode structure comprises the uncoated portion between the 0 L location and a 40 L location.

3. The electrode structure as claimed in claim 1,
wherein the electrode structure excludes the uncoated portion between a 40 L location and the 100 L location.

4. The electrode structure as claimed in claim 1,
wherein the electrode structure comprises about 1 to about 5 uncoated portions.

5. The electrode structure as claimed in claim 1,
wherein the coated portion comprises a first coated portion and a second coated portion,
wherein the first coated portion, the uncoated portion, and the second coated portion are arranged sequentially in the longitudinal direction.

6. The electrode structure as claimed in claim 1,
wherein the uncoated portion has a width of about 1 millimeter (mm) to about 15 mm.

7. The electrode structure as claimed in claim 1,
wherein the uncoated portion comprises a first uncoated portion and a second uncoated portion,
the coated portion comprises a first coated portion, a second coated portion, and a third coated portion, and
the first coated portion, the first uncoated portion, the second coated portion, the second uncoated portion, and the third coated portion are arranged sequentially in the longitudinal direction.

8. The electrode structure as claimed in claim 7,
wherein the first uncoated portion has a width equal to a width of the second uncoated portion.

9. The electrode structure as claimed in claim 7,
wherein the first uncoated portion is between the 0 L location and a 20 L location, and
the second uncoated portion is between the 20 L location and a 40 L location.

10. The electrode structure as claimed in claim 1,
wherein the electrode structure excludes an insulator.

11. The electrode structure as claimed in claim 1,
wherein the electrode structure has a winding structure or a stack-winding structure.

12. The electrode structure as claimed in claim 1,
wherein the cathode comprises a cathode current collector and the cathode active material layer on the cathode current collector,
the anode comprises an anode current collector and the anode active material layer on the anode current collector,
the cathode current collector and the anode current collector each independently comprise a base film and a metal layer on at least one side of the base film,
the base film comprises a polymer, the polymer comprising polyethylene terephthalate (PET), polyethylene (PE), polypropylene (PP), polybutylene terephthalate (PBT), polyimide (PI), or a combination thereof, and
the metal layer comprises indium (In), copper (Cu), magnesium (Mg), titanium (Ti), iron (Fe), cobalt (Co), nickel (Ni), zinc (Zn), aluminum (Al), germanium (Ge), lithium (Li), or an alloy thereof.

13. A lithium battery comprising
the electrode structure as claimed in claim 1.

14. The lithium battery as claimed in claim 13,
further comprising an electrolyte.

15. The lithium battery as claimed in claim 14,
wherein the electrolyte comprises a liquid electrolyte, a solid electrolyte, a gel electrolyte, or a combination thereof.

16. The electrode structure as claimed in claim 11,
wherein the electrode structure has the winding structure and the winding structure is wound in one direction.

17. The electrode structure as claimed in claim 16,
wherein the winding structure is wound in one direction from the 0 L location to the 100 L location.

18. The electrode structure as claimed in claim 11,
wherein the electrode structure has the stack-winding structure and the stack-winding structure has a zig-zag pattern.

19. The electrode structure as claimed in claim 18,
wherein the zig-zag pattern is at a starting point of the stack-winding structure.

20. The electrode structure as claimed in claim 18,
wherein the at least one uncoated portion has the zig-zag pattern and the at least one uncoated portion is wound in one direction.
